(19) United States
(12) Patent Application Publication
(10) Pub. No.: US 2016/0162070 A1
(43) Pub. Date: Jun. 9, 2016

(54) CAPACITIVE TOUCH PANEL AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD., Hefei City (CN)

(72) Inventors: Min HE, Beijing (CN); Ming HU, Beijing (CN)

(21) Appl. No.: 14/573,335

(22) Filed: Dec. 17, 2014

(30) Foreign Application Priority Data
Dec. 4, 2014 (CN) 201410734199.0

(51) Int. Cl. G06F 3/044

(52) U.S. Cl. CPC G06F 3/044

(57) ABSTRACT

A capacitive touch panel and a display device are provided. The capacitive touch panel includes a touch structure including at least one first wire, a plurality of first electrodes and a plurality of second electrodes; the first electrodes and the second electrodes intersect each other; each of the first electrodes includes a plurality of first sub-electrodes sequentially connected; each of the second electrodes includes a plurality of second sub-electrodes sequentially connected; the first wire each is connected with one of the first electrodes; and an orthographic projection of the first wire on the capacitive touch panel extends in at least a gap between an orthographic projection of one first sub-electrode and an orthographic projection of one second sub-electrode, on the capacitive touch panel. The capacitive touch panel can reduce the frame size and achieve the narrow-frame design.

### TECHNICAL FIELD

At least one embodiment of the present disclosure relates to a capacitive touch panel and a display device.

### BACKGROUND

With the rapid development of display technology, touch panels have been gradually widely applied in people's lives. The touch panels, according to the working principle, can be divided into resistive type, capacitive type, infrared type, surface acoustic wave type and the like. Currently, resistive touch panels and capacitive touch panels are commonly used touch panels.

The capacitive touch panel has the advantages of high sensitivity, long service life, high transmittance and the like. The working principle of the capacitive touch panel is as follows: at least one layer of transparent conductive material is disposed on a surface of a substrate to form a touch structure; and when a conductive body (e.g., a human finger) touches a surface of the capacitive touch panel, the capacitance at a touch point is changed, and the position of the touch point can be calculated according to the variation of the capacitance.

Compared with the resistive touch panel, more electrode wires are provided in the capacitive touch panel. The wires are disposed in frames of the capacitive touch panel, and hence the proportion of the screen is reduced. With the development of large-scale electronic products such as mobile phones, that a larger screen is accommodated in the case of a limited body size, namely to achieve a narrow-frame or unframed touch panel, becomes a hot research topic in the field of touch panels.

### SUMMARY

At least one embodiment of the present disclosure provides a capacitive touch panel, which includes a touch structure including a plurality of first electrodes parallel to each other and a plurality of second electrodes parallel to each other; the first electrodes and the second electrodes intersect each other; each of the first electrodes includes a plurality of first sub-electrodes sequentially connected; and each of the second electrodes includes a plurality of second sub-electrodes sequentially connected. The touch structure further includes at least one first wire; the first wire each is connected with one of the first electrodes; and an orthographic projection of the first wire, on the capacitive touch panel, extends in at least a gap between an orthographic projection of one first sub-electrode, on the capacitive touch panel, and an orthographic projection of one second sub-electrode, on the capacitive touch panel.

At least one embodiment of the present disclosure further provides a display device, which includes the above-mentioned capacitive touch panel.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1a is a schematic view of a touch structure;

FIG. 1b is an enlarged view of an area A in FIG. 1a;

FIG. 2 is a schematic view of a touch structure provided by an embodiment of the present disclosure;

FIG. 3a is a first schematic structural sectional view of an area B in FIG. 2 along a transverse direction;

FIG. 3b is a second schematic structural sectional view of the area B in FIG. 2 along the transverse direction;

FIG. 4 is a schematic structural view of sub-electrodes with a cross-shaped shape;

FIG. 5a is a schematic structural view of a capacitive touch panel provided by an embodiment of the present disclosure;

FIG. 5b is a schematic structural view of a capacitive touch panel provided by another embodiment of the present disclosure;

FIG. 5c is a schematic structural view of a capacitive touch panel provided by a further embodiment of the present disclosure; and

FIG. 5d is a schematic structural view of a capacitive touch panel provided by a still further embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

The capacitive touch panel includes a touch region (generally corresponding to a visual region) provided with a touch structure, and frame regions used for placing electrode wires, ground wires and the like. A common capacitive touch panel includes a plurality of transverse electrodes and a plurality of longitudinal electrodes; each transverse electrode and each longitudinal electrode are respectively connected with a corresponding wire; and these wires are led out to a bonding region so as to be connected with other members (e.g., a flexible printed circuit board (FPCB)). According to different touch structure designs, the transverse electrodes and the longitudinal electrodes may be provided in a same layer and may also be provided in different layers.

FIG. 1a is a schematic view of a touch structure in which transverse electrodes and longitudinal electrodes are provided in a same layer. As illustrated in FIG. 1a, the touch structure includes a plurality of transverse electrodes 021 and a plurality of longitudinal electrodes 022; the transverse electrode 021 and the longitudinal electrode 022 each, for instance, may be of a strip structure formed by etching a same ITO (indium tin oxide) layer; and each strip structure includes a plurality of diamond patterns taken as sub-electrodes. It can be seen from an enlarged view of an area A shown in FIG. 1b, a plurality of transverse sub-electrodes 0210 of each transverse electrode 021 is provided continuously along a transverse direction; a plurality of longitudinal sub-electrodes 0220 of each longitudinal electrode 022 is provided in sections along a longitudinal direction; an insulating layer 03 is disposed on the layer where the transverse electrode 021 and the longitudinal electrode 022 are located, at a position where the transverse electrode 021 intersects the longitudinal electrode 022; and a bridge line 04 configured for connecting adjacent longitudinal sub-electrodes 0220 is disposed on the insulating layer 03. In the touch structure shown in FIGS. 1a and 1b, the position of a touch point can be determined by detecting the variation of the capacitance formed at the position where the transverse electrode 021 intersects the longitudinal electrode 022, and each transverse electrode 021 and each longitudinal electrode 022 are at least connected with one wire 05 respectively.

However, the inventor of the application found in research that: in the case shown in FIG. 1, a wire 05 of each first electrode is directly led out to a frame; and in order to make the wires 05 of the first electrodes led out to a same bonding region (e.g., a region to which the ends of wires 06 of the second electrodes 022 correspond), the wires 05 of the first electrodes need be bent, and a certain distance need be provided between different wires 05 to reduce the interference between the wires 05. Thus. the panel wiring space occupied by these wires 05 is large, and hence the capacitive touch panel is difficult to achieve a narrow-frame or an unframed design.

In order to achieve a narrow-frame or an unframed design, a flexible substrate may be adopted; a touch structure is formed in a touch region of the flexible substrate; wires are formed in a frame region; and the flexible substrate is folded along a boundary between the frame region and the touch region, so that the wires and the touch structure are converted from the case of being disposed on the same side of the flexible substrate before folding to the case of being respectively facing opposite sides after folding. But this back wiring means makes against the design of a thin and light capacitive touch panel as the flexible substrate is folded and it is equivalent to add one substrate. Moreover, the back wiring means has a high requirement on the structural performance of the substrate, and hence the manufacturing cost is increased.

At least one embodiment of the present disclosure provides a capacitive touch panel and a display device. The capacitive touch panel includes a touch structure. The touch structure includes a plurality of first electrodes parallel to each other, a plurality of second electrodes parallel to each other and at least one first wire; the first electrodes and the second electrodes intersect each other; each of the first electrodes includes a plurality of first sub-electrodes sequentially connected; each of the second electrodes includes a plurality of second sub-electrodes sequentially connected; the first wire each is connected with one of the first electrodes; and an orthographic projection of the first wire, on the capacitive touch panel, extends in at least a gap between an orthographic projection of one first sub-electrode, on the capacitive touch panel, and an orthographic projection of one second sub-electrode, on the capacitive touch panel. In the embodiment of the present disclosure, as the orthographic projection of the first wire on the capacitive touch panel extends in the gap between the orthographic projection of the first sub-electrode on the capacitive touch panel and the orthographic projection of the second sub-electrode on the capacitive touch panel, the wires originally passing through a frame region are configured to pass through the touch region, and hence the number of the wires in the frame region can be greatly reduced, and this helps to achieve the narrow-frame design. Moreover, in the embodiment of the present disclosure, the wires originally occupying a plurality of frame regions may only occupy one frame region, and hence the size of a frame region can be effectively reduced and the narrow-frame design can be achieved.

It is to be noted that the touch panel provided by embodiments of the present disclosure is a capacitive touch panel, and a touch position can be determined by detecting the variation of the capacitance between a first electrode and a second electrode. Thus, each electrode may be at least connected with one wire, and each wire may be connected with any sub-electrode in the electrode with which the wire is connected. In embodiments of the present disclosure, the first wire provided in at least a gap between sub-electrodes may also be connected with any first sub-electrode of the first electrode.

As for the connection means between the first wire and the first electrode with which the first wire connected embodiments of the present disclosure are not limited thereto. For instance, the first wire may be directly lap-joint to the first sub-electrode of the first electrode or connected to the first sub-electrode of the first electrode via a through hole.

Embodiments of the present disclosure are applicable to the touch structure in which the plurality of first electrodes and the plurality of second electrodes are provided in a same layer, namely one layer of transparent conductive material is adopted to form the first electrodes and the second electrodes of the touch structure. The embodiments of the present disclosure is also applicable to the touch structure in which the plurality of first electrodes and the plurality of second electrodes are provided in different layers, namely two layers of transparent conductive material are adopted to form the first electrodes and the second electrodes of the touch structure.

Detailed description will be given below to the capacitive touch panel and the display device, provided by embodiments of the present disclosure, with reference to the accompanying drawings and the example that the plurality of first electrodes and the plurality of second electrodes are provided in a same layer and have a diamond shape. The following embodiments are only illustrative and not intended for limitation.

The thicknesses and the shapes of all parts in the accompanying drawings do not reflect the true scale and are only intended to illustrate the content of the embodiments of the present disclosure.

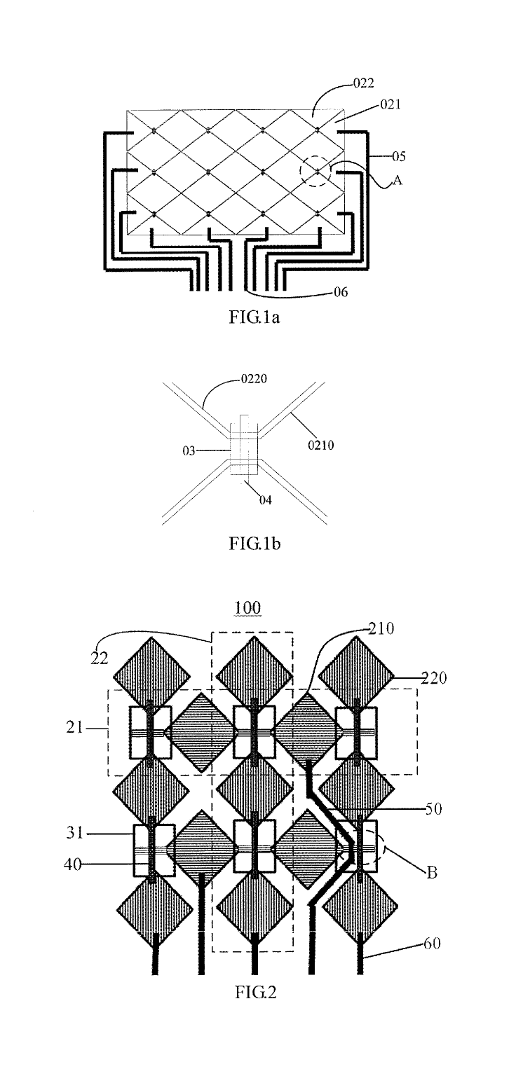

As illustrated in FIG. 2, at least one embodiment of the present disclosure provides a capacitive touch panel, which includes a touch structure 100. The touch structure 100 can include a plurality of first electrodes 21 parallel to each other and extending along a transverse direction, and a plurality of second electrodes 22 parallel to each other and extending along a longitudinal direction; the first electrodes 21 and the second electrodes 22 intersect each other; each of the first electrodes 21 includes a plurality of first sub-electrodes 210 sequentially connected; each of the second electrodes 22 includes a plurality of second sub-electrodes 220 sequentially connected; and the touch structure 100 further includes a first wire 50 connected with a first electrode 21. As the first electrodes 21 and the second electrodes 22 in FIG. 2 are provided in a same layer (namely the first sub-electrodes 210 and the second sub-electrodes 220 are provided in a same layer), that an orthographic projection of the first wire 50, on the capacitive touch panel, extends in at least a gap between an orthographic projection of one first sub-electrode 210, on the capacitive touch panel, and an orthographic projection of one second sub-electrode 220, on the capacitive touch panel, means that the first wire 50 extends in at least a gap between one first sub-electrode 210 and one second sub-electrode 220.

It is to be noted that FIG. 2 only illustrates with respect to the example that the first electrodes 21 and the second electrodes 22 respectively extend along the transverse direction and the longitudinal direction. But the first electrodes 21 and the second electrodes 22 may also respectively extend along the longitudinal direction and the transverse direction, or respectively extend along other directions.

FIG. 2 illustrates that one first wire 50 is connected with one first electrode 21. But embodiments of the present disclosure are not limited thereto. For instance, in at least one embodiment, a mode that two first wires 50 are connected to a same first electrode 21 may be adopted. At this point, the two first wires 50 are respectively connected with different first sub-electrodes 210 of the first electrode 21. By adoption of the bilateral wiring mode, when the impedance of the first electrode 21 is too large, the signal detection sensitivity for the first electrode 21 can be effectively improved.

In at least one embodiment, the first wire 50 may extend along an extension direction of the first electrode 21 or the second electrode 22. The first wire 50 is led out to a bonding region so as to be connected with other members. As illustrated in FIG. 2, if the bonding region is close to an end of the first electrode 21 (particularly when the first electrode 21 adopts the bilateral wiring mode), for instance, the bonding region is disposed on the left side of the first electrode 21, the first wire 50 may extend along the extension direction (the transverse direction) of the first electrode 21; and if the bonding region is close to an end of the second electrode 22, for instance, the bonding region is disposed at the bottom of the second electrode 22 in FIG. 2, the first wire 50 extends along the extension direction (the longitudinal direction) of the second electrode 22. Compared with the means shown in FIG. 1 that the wires of the first electrode 021 are firstly led out to frame regions on two sides and then led out to a bonding region at the bottom, the widths of the frame regions at both ends of the first electrode 21 can be effectively reduced, and hence the narrow-frame design can be achieved.

Of course, the first wire 50 is not limited to only extend along the transverse or longitudinal direction, as long as the first wire 50 extends in gaps between the sub-electrodes and extends to the bonding region.

In one embodiment, the first wire 50 extends to one frame region of the capacitive touch panel. In embodiments of the present disclosure, the first wire 50 extends in the gaps between the sub-electrodes and extends to one frame region. Thus, the first wire 50 only occupies one frame region. Compared with the case shown in FIG. 1a that each wire 05 occupies two frame regions, one frame can be saved, and this helps to achieve the narrow-frame design.

As illustrated in FIG. 2, the touch structure 100 may further include a plurality of second wires 60; each of the second wires 60 is connected with one second electrode 22; the second wire 60 is directly led out to a bonding region from an end of the second electrode 22; and the bonding region is disposed in the above-mentioned frame region. As the first wire 50 extends in gaps between the sub-electrodes, and the first wire 50 and the second wire 60 are led out to the same frame region, compared with the case shown in FIG. 1a that the first wire 05 and the second wire 06 occupy a plurality of frame regions, in embodiments of the present disclosure, the first wire 50 and the second wire 60 may only occupy one frame region, and hence the narrow-frame design can be achieved. As illustrated in FIG. 2, an area to which ends of the first wire 50 and the second wire 60 correspond (namely an area to which the bottom of the second electrode 22 corresponds) is a bonding region. In embodiments of the present disclosure, the first wire 50 is adopted when the sub-electrode connected with the wire is away from the bonding region, and the second wire 60 is adopted when the sub-electrode connected with the wire is close to the bonding region. The cooperation of the two wires improves the wiring flexibility of the wires.

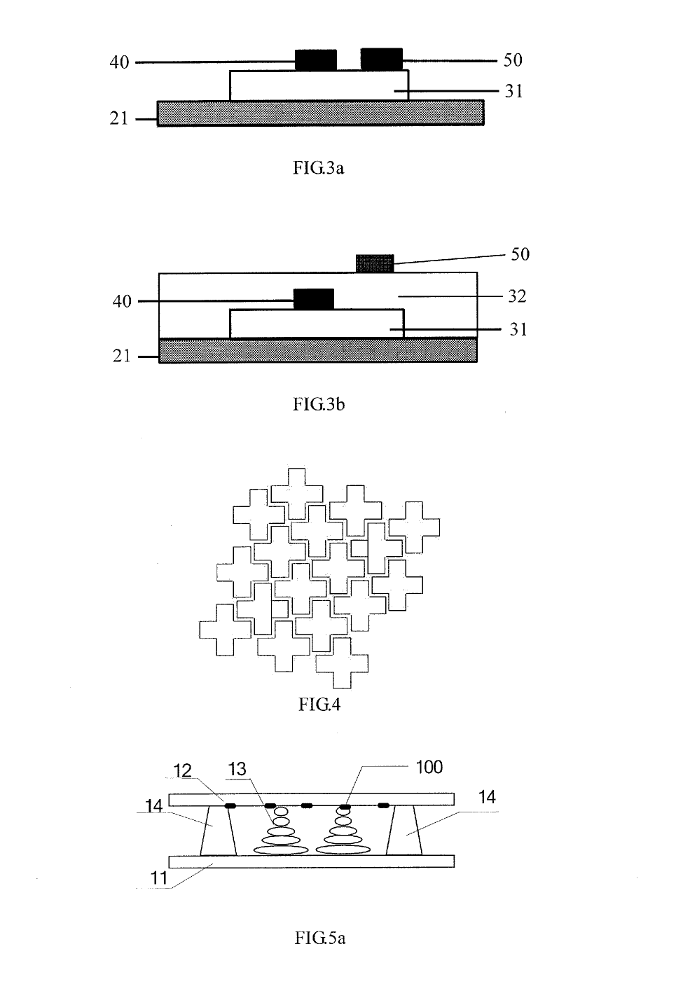

In the touch structure 100 shown in FIG. 2, the first electrodes 21 and the second electrodes 22 are provided in a same layer, namely a plurality of first sub-electrodes 210 and a plurality of second sub-electrodes 220 are provided in a same electrode layer. At this point, the touch structure 100 may adopt a bridge structure. That is to say, the first electrode 21 is provided continuously; the second electrode 22 is provided in sections; and adjacent second sub-electrodes 220 are connected with each other through the bridge structure at an intersected position between the first electrode 21 and the second electrode 22, as illustrated in FIG. 2. Or the second electrode is provided continuously; the first electrode 21 is provided in sections; and adjacent first sub-electrodes 210 are connected with each other through the bridge structure at an intersected position between the first electrode 21 and the second electrode 22. FIG. 3a is a first schematic sectional view of an area B in FIG. 2 along the transverse direction. As illustrated in FIG. 3a, the bridge structure includes a bridge line 40 and a first insulating layer 31 disposed between the bridge line 40 and the electrode layer where the first sub-electrodes 210 and the second sub-electrodes 220 are located.

As illustrated in FIG. 3a, the first wire 50 and the bridge line 40 of the bridge structure are provided in a same layer at the intersected position between the first electrode 21 and the second electrode 22. In this case, the first wire 50 and corresponding sub-electrode are directly lap-joint or connected with each other via a through hole in the first insulating layer 31, and the bridge line 40 and corresponding sub-electrode may also be directly lap-joint or connected with each other via a through hole in the first insulating layer 31. As the first wire 50 is disposed in gaps between the sub-electrodes, and the first wire 50 and the bridge line 40 are provided in a same layer at the intersected position between the first electrode 21 and the second electrode 22, the first wire 50 and the bridge line 40 may be formed of a same conductive material in a same patterning process, and this shortens the technological process.

Of course, in order to reduce the parasitic capacitance between the first wire 50 and the bridge line 40 and to achieve a more flexible wiring for the first wire 50, the bridge line 40 and the first wire 50 may also be provided in different layers. That is to say, as illustrated in FIG. 3b, the bridge structure may further include a second insulating layer 32, and the bridge line 40 and a portion of the first wire 50 at the intersected position are respectively disposed on both opposite sides of the second insulating layer 32 along a direction perpendicular to the capacitive touch panel. At this point, as the total thickness of the first insulating layer 31 and the second insulating layer 32 is relatively large, the first wire 50 (as illustrated in FIG. 3b) disposed in the uppermost layer or the bridge line is preferably connected with corresponding sub-electrode via a through hole.

In the capacitive touch panel provided by the above-mentioned embodiments of the present disclosure, the bridge line 40 may be made of metal, e.g., aluminum, aluminum alloy and copper alloy. As the metal has small resistivity, the width of the bridge line may be relatively small as a metal bridge line is adopted to connect adjacent first sub-electrodes or adjacent second sub-electrodes. Particularly when the first wire 50 and the bridge line 40 are provided in a same layer at the intersected position between the first electrode 21 and the second electrode 22, smaller space occupied by the bridge line 40 is more conducive to the setting of the first wire 50.

It is to be noted that in the above-mentioned embodiments of the present disclosure, the case that an orthographic projection of the first wire on the capacitive touch panel extends in at least a gap between an orthographic projection of one first sub-electrode on the capacitive touch panel and an orthographic projection of one second sub-electrode on the capacitive touch panel is directed against the overall trend of the first wire. For instance, as illustrated in FIG. 2, the first wire 50 extends in gaps between the first sub-electrodes 210 and the second sub-electrodes 220 on the whole, but the first wire 50 also includes a portion corresponding to the intersected position between the first electrode 21 and the second electrode 22 (e.g., a position corresponding to the area B).

The patterns of the first sub-electrodes and the second sub-electrodes are not limited in the embodiment of the present disclosure, as long as the orthographic projection of the first wire on the touch panel is disposed in gaps between the orthographic projections of sub-electrodes on the touch panel. Moreover, the sub-electrodes include at least one selected from the group consisting of the first sub-electrode and the second sub-electrode. For instance, the first sub-electrode and the second sub-electrode may adopt various structures such as a diamond shape and a cross-shaped shape (as shown in FIG. 4).

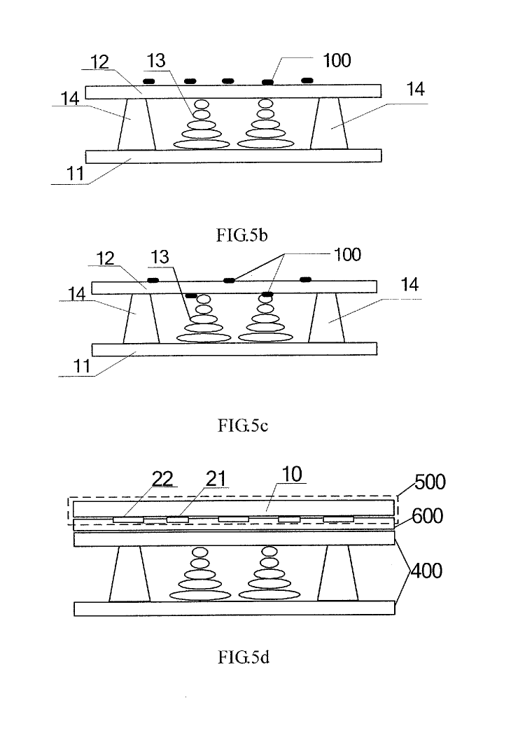

At least one embodiment of the present disclosure further provides a display device, which includes the capacitive touch panel provided by any one of the above-mentioned embodiments. The capacitive touch panel provided by the above-mentioned embodiments of the present disclosure is applicable to a plurality of display devices. Detailed description will be given below to the display device provided by the embodiment of the present disclosure with reference to FIGS. 5a and 5b.

For instance, in the display device provided by an embodiment of the present disclosure, the capacitive touch panel may further include a display module. For instance, as illustrated in FIGS. 5a to 5c, the display module may include an array substrate 12 and an opposing substrate 11 (e.g., a color filter substrate); the array substrate 12 and the opposing substrate 13 are opposite to each other to form a liquid crystal cell; a liquid crystal material 13 fills the liquid crystal cell; and spacers 14 are disposed between the array substrate 12 and the opposing substrate 13 to maintain the cell gap of the liquid crystal cell. In some embodiments, the display module may further include a backlight which provides back light to the array substrate 12. The touch structure 100 may be disposed on one side of the opposing substrate 11, facing the array substrate 12, as illustrated in FIG. 5a, or the touch structure 100 may be disposed on one side of the opposing substrate 11, away from the array substrate 12, as illustrated in FIG. 5b; or the plurality of first electrodes and the plurality of second electrodes of the touch structure 100 may be respectively disposed on two sides of the opposing substrate 11, as illustrated in FIG. 5c.

Or, for instance, as illustrated in FIG. 5d, the display device provided by embodiments of the present disclosure may further include a display panel 400 on the basis of the capacitive touch panel 500. The display panel 400 may be a liquid crystal display panel or an OLED display panel. The capacitive touch panel 500 is disposed on a display side of the display panel 400 (namely the upper side of the display panel 400 in FIG. 5d). The capacitive touch panel 500 and the display panel 400 may be laminated together via an adhesive 600. In this case, the capacitive touch panel 500 may include a substrate 10. The substrate is, for instance, a transparent substrate such as a glass substrate or a quartz substrate. The plurality of first electrodes 21 and the plurality of second electrodes 22 of the touch structure 100 may be disposed on a same side of the substrate 10 or respectively disposed on two sides of the substrate 10. FIG. 5d illustrates with respect to the example that the first electrodes 21 and the second electrodes 22 are disposed on one side of the substrate 10 facing the display panel 400.

In addition, the display device provided by embodiments of the present disclosure may be any product or component with display function such as an LCD panel, an electronic paper, an OLED panel, a mobile phone, a tablet PC, a TV, a display, a notebook computer, a digital picture frame and a navigator.

What are described above is related to the illustrative embodiments of the disclosure only and not limitative to the scope of the disclosure; the scopes of the disclosure are defined by the accompanying claims.

This application claims the benefit of Chinese Patent Application No. 201410734199.0, filed on Dec. 4, 2014, which is hereby entirely incorporated by reference.

What is claimed is:

1. A capacitive touch panel, comprising a touch structure, wherein
the touch structure comprises:
a plurality of first electrodes parallel to each other and a plurality of second electrodes parallel to each other, wherein the first electrodes and the second electrodes intersect each other; each of the first electrodes comprises a plurality of first sub-electrodes sequentially connected; and each of the second electrodes comprises a plurality of second sub-electrodes sequentially connected; and
at least one first wire, which each is connected with one of the first electrodes; and an orthographic projection of the first wire, on the capacitive touch panel, extends in at least a gap between an orthographic projection of one first sub-electrode, on the capacitive touch panel, and an orthographic projection of one second sub-electrode, on the capacitive touch panel.

2. The capacitive touch panel according to claim I, wherein the first wire is connected with any one of the first sub-electrodes of the first electrode.

3. The capacitive touch panel according to claim 2, wherein the first wire is directly lap-joint to the first sub-electrode of the first electrode or connected to the first sub-electrode of the first electrode via a through hole.

4. The capacitive touch panel according to claim 1, wherein two first wires are connected to the same first electrode and respectively connected with different first sub-electrodes of the first electrode.

5. The capacitive touch panel according to claim 1, wherein the first wire extends to a frame region of the capacitive touch panel.

6. The capacitive touch panel according to claim 5, wherein the touch structure further comprises a plurality of second wires; each of the second wires is connected with one of the second electrodes and is directly led out to a bonding region from an end of the second electrode; and the bonding region is disposed in the frame region.

7. The capacitive touch panel according to claim 1, wherein the first wire extends along an extension direction of the first electrode or the second electrode.

8. The capacitive touch panel according to claim 1, wherein the plurality of first sub-electrodes and the plurality of second sub-electrodes are provided in a same electrode layer;
the first electrode is continuously provided, the second electrode is provided in sections, and adjacent the second sub-electrodes are connected with each other through a bridge structure at an intersected position between the first electrode and the second electrode; or the second electrode is continuously provided, the first electrode is provided in sections, and adjacent the first sub-electrodes are connected with each other through the bridge structure at the intersected position between the first electrode and the second electrode connected with each other through a bridge structure; and
the bridge structure comprises a bridge line and a first insulating layer disposed between the bridge line and the electrode layer.

9. The capacitive touch panel according to claim 8, wherein the first wire and the bridge line of the bridge structure are provided in a same layer at the intersected position between the first electrode and the second electrode.

10. The capacitive touch panel according to claim 8, wherein the bridge structure further comprises a second insulating layer; and the bridge line and a portion of the first wire at the intersected position are respectively disposed on both opposite sides of the second insulating layer along a direction perpendicular to the capacitive touch panel.

11. The capacitive touch panel according to claim 8, wherein a material of the bridge line comprises metal.

12. The capacitive touch panel according to claim 1, wherein the plurality of first electrodes and the plurality of second electrodes are provided in different layers.

13. The capacitive touch panel according to claim 1, wherein the first sub-electrodes and the second sub-electrodes each have a diamond shape or a cross-shaped shape.

14. The capacitive touch panel according to claim 2, wherein two first wires are connected to the same first electrode and respectively connected with different first sub-electrodes of the first electrode.

15. The capacitive touch panel according to claim 3, wherein two first wires are connected to the same first electrode and respectively connected with different first sub-electrodes of the first electrode.

16. A display device, comprising a capacitive touch panel, wherein the capacitive touch panel comprises a touch structure, and the touch structure comprises:
a plurality of first electrodes parallel to each other and a plurality of second electrodes parallel to each other, wherein the first electrodes and the second electrodes intersect each other; each of the first electrodes comprises a plurality of first sub-electrodes sequentially connected; and each of the second electrodes comprises a plurality of second sub-electrodes sequentially connected; and
at least one first wire, wherein the first wire each is connected with one of the first electrodes; and an orthographic projection of the first wire, on the capacitive touch panel, extends in at least a gap between an orthographic projection of one first sub-electrode, on the capacitive touch panel, and an orthographic projection of one second sub-electrode, on the capacitive touch panel.

17. The display device according to claim 16, wherein the capacitive touch panel further comprises a display module, the display module comprises an array substrate and an opposing substrate; and
the touch structure is disposed on a side of the opposing substrate, away from the array substrate, or disposed on a side of the opposing substrate, facing the array substrate.

18. The display device according to claim 16, wherein the capacitive touch panel further comprises a display module, the display module comprises an array substrate and an opposing substrate; and
the plurality of first electrodes and the plurality of second electrodes of the touch structure are respectively disposed on two sides of the opposing substrate.

19. The display device according to claim 16, further comprising a display panel, wherein the capacitive touch panel is disposed on a display side of the display panel.

20. The display device according to claim 19, wherein the capacitive touch panel comprises a substrate; and the plurality of first electrodes and the plurality of second electrodes of the touch structure are disposed on a same side of the substrate or respectively disposed on two sides of the substrate.
